(19) United States
(12) Patent Application Publication
(10) Pub. No.: US 2013/0117423 A1
(43) Pub. Date: May 9, 2013

(54) METHODS FOR MANAGING DATA SYNCHRONIZATION AND DEVICES THEREOF

(71) Applicants: Puneet GUPTA, Bangalore (IN); Akshay DARBARI, Allahabad (IN); Venkat Kumar SIVARAMAMURTHY, Bangalore (IN); Ananth Prasad Konagolli SURESH, Bangalore (IN)

(72) Inventors: Puneet GUPTA, Bangalore (IN); Akshay DARBARI, Allahabad (IN); Venkat Kumar SIVARAMAMURTHY, Bangalore (IN); Ananth Prasad Konagolli SURESH, Bangalore (IN)

(73) Assignee: INFOSYS LIMITED, Bangalore (IN)

(21) Appl. No.: 13/414,939

(22) Filed: Mar. 8, 2012

(30) Foreign Application Priority Data
Nov. 9, 2011 (IN) 3845/CHE/2011

(51) Int. Cl. G06F 15/16; G06F 15/177

(52) U.S. Cl. 709/221

(57) ABSTRACT

A method, non-transitory computer readable medium, and apparatus that manage data synchronization include obtaining one or more configuration rules and at least one value for one or more configuration parameters. One or more synchronization rules are generated based on the obtained one or more configuration rules and the one or more configuration parameters. Each of the one or more generated synchronization rules are compared to a corresponding synchronization rule in an existing configuration profile. The existing configuration profile is updated based on the results of the comparison. The updated configuration profile is communicated to a client computing device.

This application claims the benefit of Indian Patent Application Filing No. 3845/CHE/2011, filed Nov. 9, 2011, which is hereby incorporated by reference in its entirety.

### FIELD

This technology generally relates to methods and devices for managing data synchronization and, more particularly, for optimizing various characteristics of data synchronization from one or more client computing devices to one or more synchronization servers.

### BACKGROUND

Data synchronization is performed on a variety of networks including those having a plurality of mobile client computing devices utilized in the field to run data collection applications, such as in the sales or parcel delivery service contexts, for example. Data is often collected at each of the client computing devices, buffered in local memory, and synchronized to one or more servers at the initiation of a user of each client computing device.

However, the client computing device may not be connected to an appropriate network, a network with available bandwidth, or any network at all, upon initiation of data synchronization by the user, in which case the user may have to recognize such an issue and reinitiate the synchronization at a later time. Such manual synchronization routines are often problematic, particularly where prompt and effective data synchronization is critical.

In more advanced deployments, the data synchronization is managed according to rules set forth by an administrator in a configuration file associated with the data collection application. However, the administrator rules, including when data synchronization is to occur, are manually generated and, therefore, often the same for each client computing device running the data collection application, resulting in parallel synchronization of many client computing devices and associated increased network and/or server load, which is not desirable.

### SUMMARY

A method for managing data synchronization includes obtaining at a synchronization management computing apparatus one or more configuration rules and at least one value for one or more configuration parameters. One or more synchronization rules are generated with the synchronization management computing apparatus based on the obtained one or more configuration rules and the one or more configuration parameters. Each of the one or more generated synchronization rules are compared with the synchronization management computing apparatus to a corresponding synchronization rule in an existing configuration profile. The existing configuration profile is updated with the synchronization management computing apparatus based on the results of the comparison. The updated configuration profile is communicated with the synchronization management computing apparatus to a client computing device.

A non-transitory computer readable medium having stored thereon instructions for managing data synchronization comprising machine executable code which when executed by at least one processor, causes the processor to perform steps including obtaining one or more configuration rules and at least one value for one or more configuration parameters. One or more synchronization rules are generated based on the obtained one or more configuration rules and the one or more configuration parameters. Each of the one or more generated synchronization rules are compared to a corresponding synchronization rule in an existing configuration profile. The existing configuration profile is updated based on the results of the comparison. The updated configuration profile is communicated to a client computing device.

A synchronization management computing apparatus including one or more processors, a memory coupled to the one or more processors which are configured to execute programmed instructions stored in the memory including obtaining one or more configuration rules and at least one value for one or more configuration parameters. One or more synchronization rules are generated based on the obtained one or more configuration rules and the one or more configuration parameters. Each of the one or more generated synchronization rules are compared to a corresponding synchronization rule in an existing configuration profile. The existing configuration profile is updated based on the results of the comparison. The updated configuration profile is communicated to a client computing device.

This technology provides a number of advantages including providing more effective methods and devices to automatically manage the synchronization of data based on synchronization rules, aggregated in a configuration profile, which are automatically updated at each client computing device based on one of administrator input or context information monitored by a synchronization management computing apparatus in communication with both the client computing device(s) and associated synchronization server device(s). With this technology, data synchronization for each client computing device can be based on a plurality of configuration parameter values which are operated on by one or more configuration rules to generate synchronization rules which are collected in a configuration profile specific to each client computing device.

With this technology, a synchronization management computing apparatus monitors changes in the context and associated configuration parameter values, the configuration rule(s), and/or synchronization rules defined by an administrator to determine whether any synchronization rule(s) and associated configuration profile(s) should be updated at one or more of the client computing devices. Thereby, this technology provides more effective and efficient management of data synchronization from a plurality of client computing devices to one or more synchronization server devices that is balanced, automatically updated over time, and configured independently for each client computing device.

### BRIEF DESCRIPTION OF THE DRAWINGS

FIG. 1 is an environment with an exemplary synchronization management computing apparatus; and

FIG. 2 is a flow chart of an exemplary method for managing data synchronization.

### DETAILED DESCRIPTION

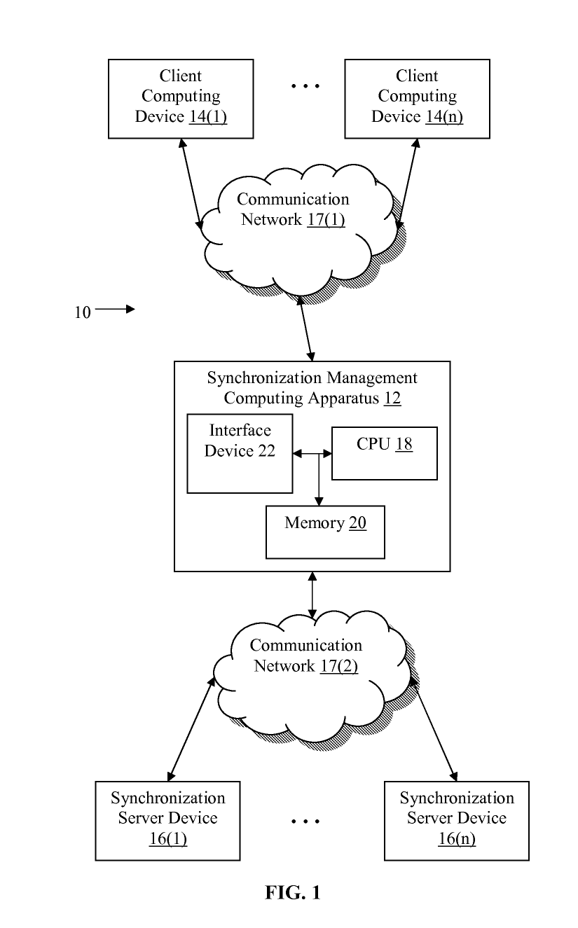

An environment 10 with an exemplary synchronization management computing apparatus 12 is illustrated in FIG. 1. The environment 10 includes the synchronization management computing apparatus 12, client computing devices 14(1)-14(n), and synchronization server devices 16(1)-16(n), which are all coupled together by one or more communication networks 17(1)-17(2), although this environment 10 can include other numbers and types of systems, devices, components, and elements in other configurations, such as multiple numbers of each of these apparatuses and devices. This technology provides a number of advantages including providing more effective methods and devices to manage data synchronization from one or more client computing devices 14(1)-14(n) to one or more synchronization server devices 16(1)-16(n).

The synchronization management computing apparatus 12 includes a central processing unit (CPU) or processor 18, a memory 20, and an interface device 22 which are coupled together by a bus or other link, although other numbers and types of systems, devices, components, and elements in other configurations and locations can be used. The processor 18 in the synchronization management computing apparatus 12 executes a program of stored instructions for one or more aspects of the present technology as described and illustrated by way of the examples herein, although other types and numbers of processing devices and logic could be used and the processor could execute other numbers and types of programmed instructions.

The memory 20 in the synchronization management computing apparatus 12 stores these programmed instructions for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The interface device 22 in the synchronization management computing apparatus 12 is used to operatively couple and communicate between synchronization management computing apparatus 12, the synchronization server devices 16(1)-16(n), and the client computing devices 14(1)-14(n) via one or more of the communications networks 17(1)-17(2), although other types and numbers of communication networks or systems with other types and numbers of connections and configurations can be used. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The client computing devices 14(1)-14(n) and the synchronization server devices 16(1)-16(n) each include a central processing unit (CPU) or processor, a memory, and an interface or I/O system, which are coupled together by a bus or other link, although each could comprise other numbers and types of devices, elements, and components in other configurations. Additionally, other types of servers, computing devices and/or other apparatuses could be used for one or more of the client computing devices 14(1)-14(n) and/or for one or more of the synchronization server devices 16(1)-16(n).

Although examples of the synchronization management computing apparatus 12, the client computing devices 14(1)-14(n), and the synchronization server devices 16(1)-16(n) coupled together via the communication networks 17(1)-17(2) are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer device or devices that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

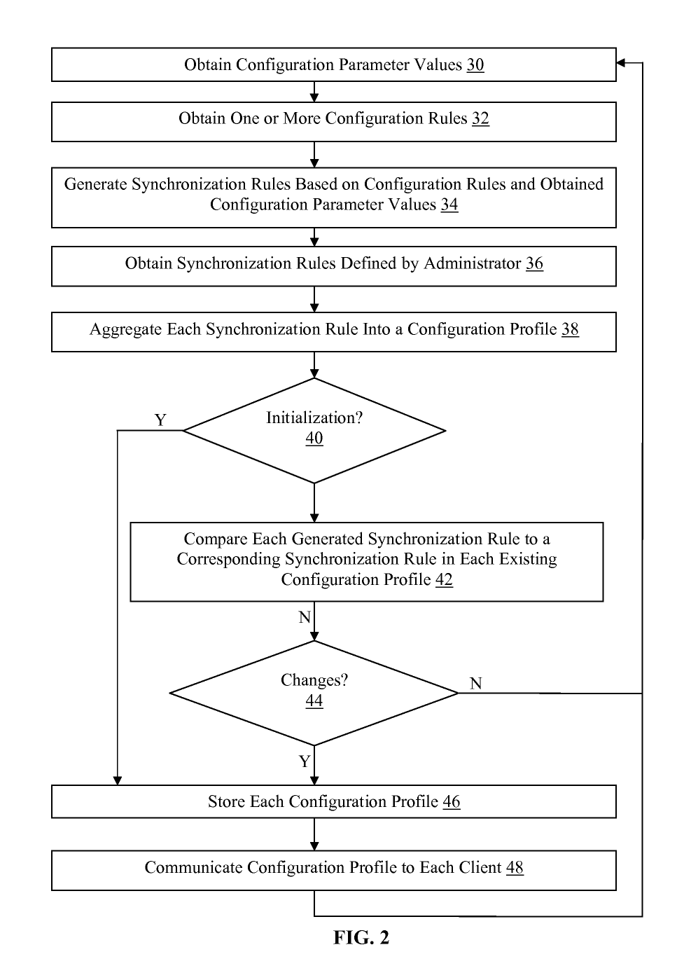

An exemplary method for managing data synchronization will now be described with reference to FIGS. 1-2. In step 30, the synchronization management computing apparatus 12 obtains at least one value for one or more configuration parameters for at least one of the client computing devices 14(1)-14(n). The configuration parameter values can be obtained by continuously or periodically monitoring various network 17, synchronization server device 16(1)-16(n), and/or client computing device 14(1)-14(n) characteristics and/or as input by a system administrator, as described below. By way of example only, monitored configuration parameters can include traffic load pattern on networks 17(1)-17(2), load pattern of one or more synchronization server devices 16(1)-16(n), number of client computing devices 14(1)-14(n) in communication with the synchronization management computing apparatus 12, number of available synchronization server devices 16(1)-16(n), and historical operational data of one or more of the server devices 16(1)-16(n) or networks 17(1)-17(2). Other monitored characteristics of networks 17(1)-17(2), synchronization server devices 16(1)-16(n), and/or client computing devices 14(1)-14(n) can further be represented as one or more configuration parameters.

Accordingly, with respect to monitored configuration parameters, in one example, the synchronization management computing apparatus 12 includes program instructions stored in memory 20 that, when executed by the processor 18, are configured to monitor traffic load pattern(s) for one or more communication networks 17(1)-17(2) utilized by one or more of the client computing devices 14(1)-14(n) and obtain one or more traffic load pattern configuration parameter values for one or more of the networks 17(1)-17(2). The traffic load pattern configuration parameter value(s) for networks 17(1)-17(2) can be obtained based on a weighted average of traffic load distribution over time for networks 17(1)-17(2) and/or can include a set of parameter values indicating the traffic load for one or more networks 17(1)-17(2) at a plurality of specified times, and/or over one or more specified time periods, for example, and/or any other method of quantifying load pattern(s) for networks 17(1)-17(2) at a point in time and/or over a period of time.

In another example, the synchronization management computing apparatus 12 includes program instructions stored in memory 20 that, when executed by the processor 18, are configured to monitor the load pattern(s) of one or more of the synchronization server devices 16(1)-16(n) used by one or more of the client computing devices 14(1)-14(n) and obtain one or more synchronization load pattern configuration parameter values for synchronization server devices 16(1)-16(n). The synchronization server load pattern configuration parameter value(s) for synchronization server devices 16(1)-16(n) can be obtained based on a weighted average of load distribution for one or more synchronization server devices 16(1)-16(n) over time and/or can include a set of configuration parameter values indicating the load on one or more synchronization server devices 16(1)-16(n) at a plurality of specified times and/or for one or more specified time periods, for example, and/or any other method of quantifying synchronization server load pattern(s) at a point in time and/or over a period of time for synchronization server devices 16(1)-16(n).

In another example, the synchronization management computing apparatus 12 includes program instructions stored in memory 20 that, when executed by the processor 18, are configured to monitor the number of synchronization server devices 16(1)-16(n) communicating with the synchronization management computing apparatus 12 and obtain an associated number of synchronization server devices 16(1)-16(n) configuration parameter value which can correspond to the number of identified server devices 16(1)-16(n), for example. Accordingly, a change in the number of identified server devices 16(1)-16(n) can indicate addition of a server devices 16(1)-16(n), removal of a server devices 16(1)-16(n), or temporary downtime of a server devices 16(1)-16(n), for example.

In another example, the synchronization management computing apparatus 12 includes program instructions stored in memory 20 that, when executed by the processor 18, are configured to monitor one or more operational characteristics, such as usage or load, of one or more of the server devices 16(1)-16(n) or networks 17(1)-17(2) over time and maintain a database of the historical operational data, such as in memory 20.

In step 32, the synchronization management computing apparatus 12 obtains one or more configuration rules configured to operate on one or more configuration parameter values to define one or more synchronization rules, as discussed in more detail below. The configuration rules can be defined by an administrator of the synchronization management computing apparatus 12 and can be monitored for any changes to a configuration rule and/or the set of configuration rules, such as an addition or subtraction of a configuration rule or an addition or subtraction of a configuration parameter input to one or more configuration rules, for example, as described in more detail below. The configuration rules can be stored in a database in memory 20 of the synchronization management computing apparatus 12, for example.

In step 34, the synchronization management computing apparatus 12 generates one or more synchronization rules for one or more client computing devices 14(1)-14(n) as specified by one or more configuration rules configured to operate on one or more configuration parameter values. Exemplary synchronization rules, whether generated at step 34 or obtained as defined by an administrator at step 36, as discussed in detail below, establish, for one or more client computing devices 14(1)-14(n), when one or more synchronizations are to be scheduled, how often one or more synchronizations are to be scheduled, how much data is to be synchronized in each synchronization session, when synchronization is to be retried subsequent to a synchronization failure, how many times a synchronization is to be retried subsequent to a synchronization failure, whether the synchronized data is to be compressed, whether the synchronized data is to be encrypted, which of one or more synchronization servers is to be utilized for the synchronized data, the size of each communication of synchronized data within a synchronization session, and any other characteristic of the synchronization of data from one of the client computing devices 14(1)-14(n) to one or more of the synchronization server devices 16(1)-16(n).

Accordingly, in one example, program instructions stored in memory 20, when executed by the processor 18, are configured to generate a synchronization rule defining when one or more synchronization sessions are to be initiated by a client computing device 14(1)-14(n) based on the output of a configuration rule configured to receive as input one or more configuration parameter values, such as a network traffic load pattern configuration parameter value and a synchronization server device load pattern configuration parameter value. Accordingly, an exemplary synchronization rule can establish that synchronization is to occur at a specific time of day and to a specific synchronization server device 16(1)-16(n) based on the output of a configuration rule for one or more computing devices 14(1)-14(n). The configuration rule can be configured to interpret the network traffic load pattern configuration parameter value, the synchronization server device 16(1)-16(n) load pattern configuration parameter value, and/or the historical operational data parameter value, each obtained at step 30, to generate an output of a time of day and a specific synchronization server device 16(1)-16(n) based on an optimization of the configuration parameter value inputs. The output is then utilized to generate a synchronization rule applicable to one or more client computing devices 14(1)-14(n) defining when synchronization is to occur.

In another example, program instructions stored in memory 20, when executed by the processor 18, are configured to generate a synchronization rule defining how much data is to be synchronized, in each synchronization session, by one or more client computing devices 14(1)-14(n) based on the output of a configuration rule configured to receive as input one or more configuration parameter values such as a synchronization server device 16(1)-16(n) load pattern configuration parameter value and a network 17(1)-17(2) traffic load pattern configuration parameter value. Accordingly, an exemplary configuration rule can output a relatively high data size value when the synchronization server device 16(1)-16(n) load pattern configuration parameter value and/or network 17(1)-17(2) traffic load pattern configuration parameter value is below a threshold for a at the specified time, indicating low network 17(1)-17(2) and synchronization server 16(1)-16(n) load and capacity to manage a relatively large amount of data in a synchronization session.

In another example, program instructions stored in memory 20, when executed by the processor 18, are configured to generate a synchronization rule defining which of one or more synchronization servers 16(1)-16(n) is to be utilized for storing synchronized data by one or more client computing devices 14(1)-14(n) based on the output of a configuration rule configured to receive as input one or more configuration parameter values such as synchronization server device 16(1)-16(n) load pattern configuration parameter value and a number of synchronization server devices 16(1)-16(n) configuration parameter value. Accordingly, an exemplary configuration rule can output a value identifying one of the synchronization server devices 16(1)-16(n) having a relatively low, but greater than zero, associated synchronization server device 16(1)-16(n) load pattern configuration parameter value if the number of synchronization server devices 16(1)-16(n) configuration parameter value is not equal to a specified number indicating one or more synchronization server device 16(1)-16(n) outages. Thereby, synchronized data communications are directed to the synchronization server device 16(1)-16(n) with the least load when one or more other synchronization server devices 16(1)-16(n) go offline.

In another example, program instructions stored in memory 20, when executed by the processor 18, are configured to generate a synchronization rule defining the size of each communication of synchronized data within a synchronization session by one or more client computing devices 14(1)-14(n) based on the output of a configuration rule configured to receive as input one or more configuration parameter values such as a synchronization server device 16(1)-16(n) load pattern configuration parameter value. Accordingly, an exemplary configuration rule can output a specific data size value when the synchronization server device 16(1)-16(n) load pattern configuration parameter value is above a threshold in an attempt to mitigate packet loss.

Various other permutations of the configuration parameters identified above, or any other configuration parameters not set forth above, and configuration parameter values can be utilized by one or more of the configuration rules identified above, or any other configuration rule not set forth above, to generate one or more of the synchronization rules identified above, or any other synchronization rules not set forth above. Additionally, a synchronization rule can be generated for a plurality of client computing devices 14(1)-14(n) based on the same or different configuration parameter values, and/or generated independently for each client computing device 14(1)-14(n).

Optionally, one or more synchronization rules can be defined by an administrator and can further be conditional rules based on one or more input values as determined at one or more of the client computing devices 14(1)-14(n). Accordingly, at step 36, the synchronization management computing apparatus 12 obtains one or more synchronization rules defined by an administrator. By way of example only, the synchronization rules defined by an administrator can be based on one or more inputs including priority of synchronized data to be communicated by one or more client computing devices 14(1)-14(n), enterprise network connectivity, bandwidth of network 17(1), technology supported by one or more client computing devices 14(1)-14(n), geographic location of one or more client computing devices 14(1)-14(n), one or more user profiles associated with one or more client computing devices 14(1)-14(n), power supply status of one or more client computing devices 14(1)-14(n), storage space status of one or more client computing devices 14(1)-14(n), processor status of one or more client computing devices 14(1)-14(n), memory status of one or more client computing devices 14(1)-14(n), availability of one or more of the networks 17(1), operator of a network 17(1) to which one or more client computing devices 14(1)-14(n) is connected, billing rate of network 17(1) to which one or more client computing devices 14(1)-14(n) is connected, usage pattern of the data collection application at one or more client computing devices 14(1)-14(n), and type of data collection application associated with the synchronized data.

Accordingly, the synchronization rules defined by an administrator can be based on the above inputs as determined at each client computing device 14(1)-14(n). For example, with respect to the priority of synchronized data, a data collection program application operating on one or more client computing devices 14(1)-14(n) can be configured to encode data to be synchronized based on type (e.g. inventory and/or sales) or relative priority (e.g. low, medium, and/or high or an integer value on a relative scale). In the former case, a database in memory of a client computing device 14(1)-14(n) can be configured to correlate the data type to a priority value.

With respect to enterprise network connectivity, a client computing device 14(1)-14(n) can be configured to compare the network service set identifier (SSID), or another value or indicator, to determine whether the network 17(1) to which the client computing device 14(1)-14(n) is currently connected is a corporate or enterprise network.

With respect to bandwidth of network 17(1), a client computing device 14(1)-14(n) can be configured to determine the bandwidth characteristics (e.g. 2G, 3G, 4G, and/or 100 Mbits/s) of the network 17(1) to which is it currently connected, such as by communicating with a network interface.

With respect to technology supported by one or more client computing devices 14(1)-14(n), a client computing device 14(1)-14(n) can be configured to not only the bandwidth of network 17(1) as discussed above, but the technology (e.g. 2G, 3G, and/or 4G) supported by the client computing device 14(1)-14(n) hardware, software, and/or subscribed plan.

With respect to geographic location of one or more client computing devices 14(1)-14(n), a client computing device 14(1)-14(n) can be configured to determine its global positioning system (GPS) coordinates, such as by communicating with positioning circuitry, or any other indication of current location.

With respect to one or more user profiles associated with one or more client computing devices 14(1)-14(n), a client computing device 14(1)-14(n) can be configured to determine the profile or role of the current user (e.g. sales person, manager, executive, officer, field agent, marketing employee, and/or warehouse employee) such as by comparing credentials received by the data collection program application to a database correlating credentials (e.g. user name) and user profile.

With respect to power supply status, storage space status, and/or memory status of one or more client computing devices 14(1)-14(n), a client computing device 14(1)-14(n) can be configured to determine the remaining battery life, available storage space, processor usage, and/or available memory, such as by utilizing an operating system application programming interface (API), for example.

With respect to network 17(1) availability a client computing device 14(1)-14(n) can be configured to determine, such as based on SSID, whether it is connected to a preferred network, as determined by referencing a database correlating SSIDs and availability preference, and/or can be configured to determine whether it is connected to any network at all, such as based on a network interface ping.

With respect to operator of a network 17(1) to which one or more client computing devices 14(1)-14(n) is connected, a client computing device 14(1)-14(n) can be configured to determine the operator (e.g. AT&T and/or Verizon) of the network 17(1) to which it is currently connected, such as by reference to information stored on the subscriber identity module (SIM) card currently in use.

With respect to billing rate of network 17(1) to which one or more client computing devices 14(1)-14(n) is connected, a client computing device 14(1)-14(n) can be configured to reference a database stored in memory and correlating network 17(1) operator information to one or more data billing rates.

With respect to usage pattern of one or more client computing devices 14(1)-14(n), a client computing device 14(1)-14(n) can be configured to maintain a record, such as in a database stored in memory, of when and/or how often a data collection program application is used on the client computing device 14(1)-14(n).

With respect to type of data collection application associated with the synchronized data, a client computing device 14(1)-14(n) can include a plurality of data collection applications and can be configured to maintain an association of data to be synchronized with each respective data collection application.

With respect to synchronization rules defined by an administrator, in one example, an administrator can input to the synchronization management computing apparatus 12 a synchronization rule indicating that synchronization is to occur immediately whenever at least one of the data to be synchronized is of a threshold priority value, the battery status is below a threshold value, the storage space status is below a threshold value, or the memory status is below a threshold value, for example.

In another example, an administrator can input to the synchronization management computing apparatus 12 a synchronization rule indicating that synchronized data is to be communicated to a specific synchronization server 16(1)-16(n) based on geographic location of the client computing device 14(1)-14(n) such that the distance traveled by the data is optimized.

In another example, an administrator can input to the synchronization management computing apparatus 12 a synchronization rule indicating that synchronized data is to be encrypted whenever the client computing device 14(1)-14(n) is not connected to an enterprise network.

In another example, an administrator can input to the synchronization management computing apparatus 12 a synchronization rule indicating that synchronized data is to be compressed whenever the network 17(1) bandwidth is below a threshold value.

In another example, an administrator can input to the synchronization management computing apparatus 12 a synchronization rule indicating that only synchronized data above a threshold priority value is to be synchronized as scheduled when the network 17(1) billing rate is above a threshold level.

In another example, an administrator can input to the synchronization management computing apparatus 12 a synchronization rule indicating that data associated with one data collection application operating on the client computing device 14(1)-14(n) is to be synchronized before data associated with another data collection application operating on the client computing device 14(1)-14(n).

Various other permutations of synchronization rules defined by an administrator are possible and the above exemplary synchronization rules can be based on one more of the above inputs, or any other inputs determined at the client computing device 14(1)-14(n). Moreover, one or more the synchronization rules defined by an administrator can be configured to have higher or lower priority when conflicting with one or more generated synchronization rules for one or more specific client computing devices 14(1)-14(n).

In step 38, each synchronization rule associated with a specific client computing devices 14(1)-14(n) is optionally aggregated into a respective configuration profile, though other methods of maintaining the association of synchronization rule(s) to each client computing device 14(1)-14(n) are possible.

In step 40, the synchronization management computing apparatus 12 determines whether a client computing device 14(1)-14(n) is being initialized and synchronization rules established for the first time. To determine whether any configuration profile is a first configuration profile for any client computing devices 14(1)-14(n), the synchronization management computing apparatus 12 is configured to maintain a database, in memory 20, of each existing client computing devices 14(1)-14(n) configuration profile mapped to a unique identifier, such as a MAC address, for each client computing device 14(1)-14(n). Accordingly, the synchronization management computing apparatus 12 is configured to query the database to determine whether an entry for each client computing device 14(1)-14(n) exists and/or whether any existing entry includes a reference to an existing configuration profile.

In step 46, if a client computing device does not have an existing configuration profile, the synchronization management computing apparatus 12 stores the currently generated configuration profile in the configuration profile database in the synchronization management computing apparatus 12.

In step 48, the synchronization management computing apparatus 12 communicates the initial configuration profile to the client computing device(s) 14(1)-14(n). Accordingly, data synchronization on a client computing device 14(1)-14(n) is instructed by the configuration profile, which can be stored in the same respective location on the client computing devices 14(1)-14(n) as a configuration file, and which can be interpreted by a data collection and communication program application previously installed on the client computing devices 14(1)-14(n) and configured to locate and appropriately interpret the configuration file.

In step 42, if the client computing device does have an existing configuration profile, the synchronization management computing apparatus 12 compares each synchronization rule for the client computing devices 14(1)-14(n) to a corresponding synchronization rule, if any, in the respective existing configuration profile. Although one or more of the monitored configuration parameter values, and/or configuration rules may have changed subsequent to the generation of one or more existing synchronization rules, each of the corresponding, currently generated synchronization rules may be equivalent to the existing synchronization rules, in which case the synchronization management computing apparatus 12 continues to monitor network 17(1)-17(2), synchronization server 16(1)-16(n), and/or client computing device 14(1)-14(n) characteristics by obtaining configuration parameter values at step 30.

However, if one or more of the synchronization rules have changed due to a change in one or more of the monitored configuration parameter values and/or one or more of the configuration rules subsequent to the generation of one or more of the existing synchronization rules, a synchronization rule having been redefined by an administrator in the intervening period, and/or a new synchronization rule having been generated at step 34 or defined at step 36 that does not have a corresponding synchronization rule in the existing configuration profile, the synchronization management computing apparatus 12 stores the updated configuration profile, such as in memory 20, at step 46, such as by replacing any existing synchronization rule with the corresponding, currently generated or obtained synchronization rule in the previously stored configuration profile or by replacing the existing configuration profile with the updated configuration profile.

At step 48, the synchronization management computing apparatus 12 communicates the updated configuration profile to the client computing device(s) 14(1)-14(n). Upon receipt of the updated configuration profile, the client computing device(s) 14(1)-14(n), and specifically a data collection and communication program application, for example, can be configured to replace the previously stored configuration file with the updated configuration profile information. Subsequent to communicating the updated configuration profile, the synchronization management computing apparatus 12 can continue to monitor network 17(1)-17(2), synchronization server 16(1)-16(n), and/or client computing devices 14(1)-14(n) characteristics by obtaining configuration parameter values at step 30.

Subsequent to a determination by the synchronization management computing apparatus 12 that there are no changes to synchronization rules at step 44, or subsequent to communicating an updated configuration profile at step 48, in a continuous active monitoring example, the synchronization computing apparatus 12 can immediately proceed to obtain one or more configuration values at step 30. However, such continuous monitoring can be taxing on the synchronization management computing apparatus 12, as well as one or more of the networks 17(1)-17(2). Accordingly, in one example, periodic active monitoring is utilized whereby a period of time, as specified by an administrator, for example, elapses prior to the synchronization management apparatus 12 again obtaining configuration parameter values at step 30. In another example, a passive monitoring mode is utilized whereby the synchronization management computing apparatus 12 only proceeds to step 34 upon being prompted, such as by an external device, regarding one or more network 17(1)-17(2), synchronization server 16(1)-16(n), and/or client computing devices 14(1)-14(n) characteristics and/or synchronization rules defined by an administrator, possibly resulting in a change in one or more configuration parameter values, one or more configuration rules and/or one or more synchronization rules.

Accordingly, as illustrated and described with the examples herein this technology provides more effective methods and devices for managing data synchronization. The synchronization management computing apparatus 12 is configured to monitor contextual information such as a plurality of network 17(1)-17(2), synchronization server 16(1)-16(n), and/or client computing device 14(1)-14(n) characteristics, in order to inform and/or optimize specified synchronization characteristics through the use of synchronization rules which can be aggregated to form a configuration profile specific to each client computing device 14(1)-14(n). Thereby, the configuration profile and/or configuration files stored on each of a plurality of client computing devices can be altered periodically, automatically, and independently with respect to any other client computing devices 14(1)-14(n) associated with the synchronization management computing apparatus 12. By such methods of establishing and updating configuration profiles automatically and independent for each of a plurality of client computing devices 14(1)-14(n), the synchronization management computing apparatus 12 can reduce and/or balance network 17(1)-17(2) and server 16(1)-16(n) load as well as optimize the communication of high priority data, among other advantages.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing data synchronization, the method comprising:
obtaining at a synchronization management computing apparatus one or more configuration rules and at least one value for one or more configuration parameters;
generating with the synchronization management computing apparatus one or more synchronization rules based on the obtained one or more configuration rules and the one or more configuration parameters;
comparing with the synchronization management computing apparatus each of the one or more generated synchronization rules to a corresponding synchronization rule in an existing configuration profile;
updating with the synchronization management computing apparatus the existing configuration profile based on the results of the comparison;
communicating with the synchronization management computing apparatus the updated configuration profile to a client computing device.

2. The method as set forth in claim 1 wherein the updating further comprises:
replacing the corresponding synchronization rule with the generated synchronization rule for each generated synchronization rule differing from the corresponding synchronization rule in the existing configuration profile; and
including the generated synchronization rule in the existing configuration profile for each generated synchronization rule for which there is no corresponding synchronization rule in the existing configuration profile.

3. The method as set forth in claim 1 wherein the configuration parameters are selected from at least one of network traffic load pattern, load pattern of one or more synchronization server devices, number of client computing devices in communication with the synchronization management computing apparatus, number of synchronization server devices available, or historical operational data.

4. The method as set forth in claim 1 wherein the one or more synchronization rules are selected from at least one of when one or more synchronizations are to be scheduled, how often one or more synchronizations are to be scheduled, how much data is to be synchronized in each synchronization session, when synchronization is to be retried subsequent to a synchronization failure, how many times a synchronization is to be retried subsequent to a synchronization failure, whether the synchronized data is to be compressed, whether the synchronized data is to be encrypted, which of one or more synchronization servers is to be utilized for the synchronized data, or the size of each communication of synchronized data within a synchronization session.

5. The method as set forth in claim 1 further comprising:
obtaining at synchronization management computing apparatus one or more synchronization rules as defined by an administrator;
comparing with the synchronization management computing apparatus each of the one or more synchronization rules defined by an administrator to a corresponding synchronization rule in an existing configuration profile; and
updating with the synchronization management computing apparatus the existing configuration profile based on the results of the comparison.

6. The method as set forth in claim 5 wherein the synchronization rules defined by an administrator are configured to receive one or more inputs selected from at least one of priority of synchronized data communicated by one or more of the client computing devices, enterprise network connectivity, network bandwidth, geographic location of one or more client computing devices, client computing device user profile, client computing device power supply status, client computing device storage space status, client computing device memory status, client computing device network identification, network operator, network billing rate, data collection application usage pattern, type of data collection application, or technology supported.

7. A non-transitory computer readable medium having stored thereon instructions for managing data synchronization comprising machine executable code which when executed by at least one processor, causes the processor to perform steps comprising:
obtaining one or more configuration rules and at least one value for one or more configuration parameters;
generating one or more synchronization rules based on the obtained one or more configuration rules and the one or more configuration parameters;
comparing each of the one or more generated synchronization rules to a corresponding synchronization rule in an existing configuration profile;
updating with the synchronization management computing apparatus the existing configuration profile based on the results of the comparison; and
communicating the updated configuration profile to a client computing device.

8. The medium as set forth in claim 7 wherein the updating further comprises:
replacing the corresponding synchronization rule with the generated synchronization rule for each generated synchronization rule differing from the corresponding synchronization rule in the existing configuration profile; and
including the generated synchronization rule in the existing configuration profile for each generated synchronization rule for which there is no corresponding synchronization rule in the existing configuration profile.

9. The medium as set forth in claim 7 wherein the configuration parameters are selected from at least one of network traffic load pattern, load pattern of one or more synchronization server devices, number of client computing devices in communication with the synchronization management computing apparatus, number of synchronization server devices available, or historical operational data.

10. The medium as set forth in claim 7 wherein the one or more synchronization rules are selected from at least one of when one or more synchronizations are to be scheduled, how often one or more synchronizations are to be scheduled, how much data is to be synchronized in each synchronization session, when synchronization is to be retried subsequent to a synchronization failure, how many times a synchronization is to be retried subsequent to a synchronization failure, whether the synchronized data is to be compressed, whether the synchronized data is to be encrypted, which of one or more synchronization servers is to be utilized for the synchronized data, or the size of each communication of synchronized data within a synchronization session.

11. The medium as set forth in claim 7 further having stored thereon instructions for managing data synchronization comprising machine executable code which when executed by the at least one processor, causes the processor to perform steps further comprising:
obtaining at synchronization management computing apparatus one or more synchronization rules as defined by an administrator;
comparing with the synchronization management computing apparatus each of the one or more synchronization rules defined by an administrator to a corresponding synchronization rule in an existing configuration profile; and
updating with the synchronization management computing apparatus the existing configuration profile based on the results of the comparison.

12. The medium as set forth in claim 11 wherein the synchronization rules defined by an administrator are configured to receive one or more inputs selected from at least one of priority of synchronized data communicated by one or more of the client computing devices, enterprise network connectivity, network bandwidth, geographic location of one or more client computing devices, client computing device user profile, client computing device power supply status, client computing device storage space status, client computing device memory status, client computing device network identification, network operator, network billing rate, data collection application usage pattern, type of data collection application, or technology supported.

13. A synchronization management computing apparatus comprising:
one or more processors;
a memory coupled to the one or more processors which are configured to execute programmed instructions stored in the memory comprising:
obtaining one or more configuration rules and at least one value for one or more configuration parameters;
generating one or more synchronization rules based on the obtained one or more configuration rules and the one or more configuration parameters;
comparing each of the one or more generated synchronization rules to a corresponding synchronization rule in an existing configuration profile;
updating with the synchronization management computing apparatus the existing configuration profile based on the results of the comparison; and
communicating the updated configuration profile to a client computing device.

14. The apparatus as set forth in claim 13 wherein the updating further comprises:
replacing the corresponding synchronization rule with the generated synchronization rule for each generated synchronization rule differing from the corresponding synchronization rule in the existing configuration profile; and
including the generated synchronization rule in the existing configuration profile for each generated synchronization rule for which there is no corresponding synchronization rule in the existing configuration profile.

15. The apparatus as set forth in claim 13 wherein the configuration parameters are selected from at least one of network traffic load pattern, load pattern of one or more synchronization server devices, number of client computing devices in communication with the synchronization management computing apparatus, number of synchronization server devices available, or historical operational data.

16. The apparatus as set forth in claim 13 wherein the one or more synchronization rules are selected from at least one of when one or more synchronizations are to be scheduled, how often one or more synchronizations are to be scheduled, how much data is to be synchronized in each synchronization session, when synchronization is to be retried subsequent to a synchronization failure, how many times a synchronization is to be retried subsequent to a synchronization failure, whether the synchronized data is to be compressed, whether the synchronized data is to be encrypted, which of one or more synchronization servers is to be utilized for the synchronized data, or the size of each communication of synchronized data within a synchronization session.

17. The apparatus as set forth in claim 13 wherein the memory coupled to the one or more processors is further configured to execute programmed instructions stored in the memory further comprising:
obtaining at synchronization management computing apparatus one or more synchronization rules as defined by an administrator;
comparing with the synchronization management computing apparatus each of the one or more synchronization rules defined by an administrator to a corresponding synchronization rule in an existing configuration profile; and
updating with the synchronization management computing apparatus the existing configuration profile based on the results of the comparison.

18. The apparatus as set forth in claim 17 wherein the synchronization rules defined by an administrator are configured to receive one or more inputs selected from at least one of priority of synchronized data communicated by one or more of the client computing devices, enterprise network connectivity, network bandwidth, geographic location of one or more client computing devices, client computing device user profile, client computing device power supply status, client computing device storage space status, client computing device memory status, client computing device network identification, network operator, network billing rate, data collection application usage pattern, type of data collection application, or technology supported.
